(19) United States
(12) Patent Application Publication
(10) Pub. No.: US 2026/0170671 A1
(43) Pub. Date: Jun. 18, 2026

(54) TRACKING APPARATUS AND METHOD

(71) Applicant: HTC Corporation, Taoyuan City (TW)

(72) Inventor: Chih-An TSAO, Taoyuan City (TW)

(21) Appl. No.: 18/977,954

(22) Filed: Dec. 12, 2024

(51) Int. Cl. G06T 7/521; G06T 7/586; G06T 7/73

(52) U.S. Cl. CPC G06T 7/521; G06T 7/586; G06T 7/74; G06T 7/75; G06T 2207/20081

(57) ABSTRACT

A tracking apparatus and method are provided. The apparatus calculates tracking errors under hypothetical structured light intensities at a tracking time point based on continuous images and past structured light intensities corresponding to a time interval, wherein the tracking time point is later than the time interval. The apparatus determines an optimum structured light intensity based on a minimum error among the tracking errors. The apparatus generates a control signal to control a light emitting unit to emit structured light with the optimum structured light intensity at the tracking time point. The apparatus obtains a tracking image captured at the tracking time point from a camera. The apparatus tracks a pose of a first object based on the tracking image.

### BACKGROUND

### Field of Invention

The present disclosure relates to tracking apparatus and method. More particularly, the present disclosure relates to tracking apparatus and method for low light environment.

### Description of Related Art

In the current computer vision (CV) technology, in order to overcome the problem of insufficient light in the tracking scenario, the tracking apparatus emits flood light on the object to be tracked. In the meantime, the tracking apparatus also emits structured light to perform depth sensing. If there is not enough ambient light in the tracking scenario, the tracking apparatus may emit the flood light and the structured light simultaneously to provide enough light.

However, if the flood light and the structured light are projected at the same time while the tracking apparatus performs object tracking, the accuracy of object tracking will be reduced by the pattern of the structured light.

In view of this, how to reduce the interference from the structured light while providing enough light to track objects is the goal that the industry strives to work on.

### SUMMARY

The disclosure provides a tracking apparatus comprising a first camera, a light emitting unit, and a processor. The first camera is configured to capture a plurality of first continuous images in an environment over a time interval. The light emitting unit is configured to emit structured light to the environment. The processor is coupled to the first camera and the light emitting unit and configured to execute the following operations: calculating a plurality of tracking errors under a plurality of hypothetical structured light intensities at a tracking time point based on the first continuous images and a plurality of past structured light intensities corresponding to the time interval, wherein the tracking time point is later than the time interval; determining an optimum structured light intensity based on a minimum error among the tracking errors; generating a first control signal to control the light emitting unit to emit the structured light with the optimum structured light intensity at the tracking time point; obtaining a tracking image captured at the tracking time point from the first camera; and tracking a pose of a first object based on the tracking image.

The disclosure further provides a tracking method being adapted for use in an electronic apparatus, wherein the tracking method comprises the following steps: capturing a plurality of first continuous images in an environment over a time interval; calculating a plurality of tracking errors under a plurality of hypothetical structured light intensities at a tracking time point based on the first continuous images and a plurality of past structured light intensities corresponding to the time interval, wherein the tracking time point is later than the time interval; determining an optimum structured light intensity based on a minimum error among the tracking errors; emitting structured light with the optimum structured light intensity at the tracking time point; and tracking a pose of a first object based on a tracking image captured at the tracking time point.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a tracking apparatus according to a first embodiment of the present disclosure.

FIG. 2 is a schematic diagram illustrating a time-sharing mode for controlling structured light and flood light according to some embodiments of the present disclosure.

FIG. 3 is a schematic diagram illustrating another time-sharing mode for controlling structured light and flood light according to some embodiments of the present disclosure.

FIG. 4 is a schematic diagram illustrating continuous images and a reference image for training the loss model according to some embodiments of the present disclosure.

FIG. 5 is a flow diagram illustrating a tracking method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

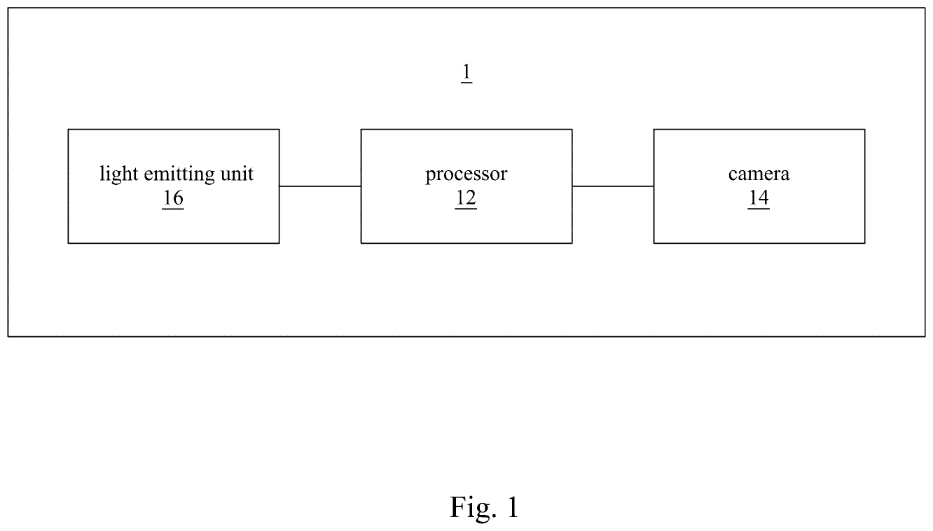

Please refer to FIG. 1, which is a schematic diagram illustrating a tracking apparatus 1 according to a first embodiments of the present disclosure. The tracking apparatus 1 comprises a processor 12, a camera 14, and a light emitting unit 16. The processor 12 electrically connects to the camera 14 and the light emitting unit 16 respectively. The tracking apparatus 1 is configured to determine an optimum structured light intensity and track the pose of an object with structured light for fill light.

The processor 12 is configured to control the camera 14 and the light emitting unit 16 and perform calculation. Specifically, the processor 12 determines when to emit structured light and/or flood light via the light emitting unit 16 and the light intensities thereof. Also, the processor 12 performs object tracking and/or depth sensing based on images captured by the camera 14. In some embodiments, the processor 12 comprises a central processing unit (CPU), a graphics processing unit (GPU), a multi-processor, a distributed processing system, an application specific integrated circuit (ASIC), and/or a suitable processing unit.

The camera 14 configured to capture a plurality of continuous images in an environment over a time interval. In some embodiments, the camera 14 is a data access circuit configured to capture images, a video camera, or a camera capable of taking images continuously. For example, the camera 14 comprises a digital single-lens reflex camera (DSLR), a digital video camera (DVC), or a near-infrared camera (NIRC).

In some embodiments, the camera 14 also comprises a depth camera to capture depth images. Accordingly, the tracking apparatus 1 is able to perform depth sensing based on the depth images.

The light emitting unit 16 is configured to emit structured light to an environment, wherein the structured light may comprise specific pattern or color arrangement to assist in depth sensing function. For example, the light emitting unit 16 comprises an infrared light-emitting diode (IR LED) to emit infrared light.

In some embodiments, the light emitting unit 16 is also configured to emit flood light to assist in object tracking function, specifically the object tracking function based on computer vision.

It is noted that, in some embodiments, the light emitting unit 16 comprises a set of light-emitting diodes for emitting both structured light and flood light. In another embodiment, the light emitting unit 16 comprises a set of light-emitting diodes for emitting structured light and another set of light-emitting diodes for emitting flood light.

In the embodiment of the tracking apparatus 1 configured to perform both depth sensing and object tracking, while the tracking apparatus 1 performs object tracking, in response to different tracking scenarios, the tracking apparatus 1 will switch to different modes to control the light emitting unit 16 emitting structured light and/or flood light.

In an embodiment, when the object tracking function is enabled, the tracking apparatus 1 controls the light emitting unit 16 as shown in the table 1 below, wherein SL represents structured light, and FL represents flood light.

TABLE 1

| | enough light | low light | not enough light |
|---|---|---|---|
| depth sensing off | SL off, FL off | SL off, FL on | SL on, FL on |
| depth sensing on | SL on, FL off | time-sharing | time-sharing |
| | | mode 1 | mode 2 |

According to the table above, as shown in the second row, when the depth sensing function is disabled, the tracking apparatus 1 does not have to turn on the structured light and the flood light to track objects if there is enough ambient light. Relatively, the tracking apparatus 1 turns on the flood light for fill light if the ambient light is low. Moreover, if the ambient light is too low for object tracking and the flood light is not enough to fill in the light, the tracking apparatus 1 also turns on the structured light to provide additional light.

In some embodiments, to achieve the operation above, the tracking apparatus 1 may set two thresholds to determine the circumstances corresponding to the ambient light. Specifically, in response to an ambient brightness in the environment lower than a first threshold, the processor 12 generates a second control signal to control the light emitting unit to emit the flood light and stop emitting the structured light to let the camera to capture the first continuous images. Also, in response to the ambient brightness in the environment lower than a second threshold, the processor 12 generates a third control signal to control the light emitting unit to emit the flood light and the structured light to let the camera to capture the first continuous images, wherein the second threshold is lower than the first threshold.

On the other hand, as shown in the third row, when the depth sensing function is enabled and the ambient light is enough, the tracking apparatus 1 turns on the structured light to support depth sensing and does not have to turn on the flood light for object tracking.

Relatively, if the ambient light is low, since the light requirements of object tracking and depth sensing are different, the tracking apparatus 1 executes object tracking and depth sensing alternatively in time and switches between different light configurations correspondingly.

Specifically, in response to a tracking function and a depth sensing function being activated at the same time, after tracking the pose of the first object, the processor 12 generates a fourth control signal to control the light emitting unit to emit the structured light and stop emitting the flood light; and after generating the fourth control signal, the processor 12 executes the depth sensing function. Additionally, after completing the depth sensing function, the processor 12 generates a fifth control signal to control a flood light intensity of the flood light and a structured light intensity of the structured light emitted by the light emitting unit; and after generating the fifth control signal, the processor 12 tracks the pose of the first object.

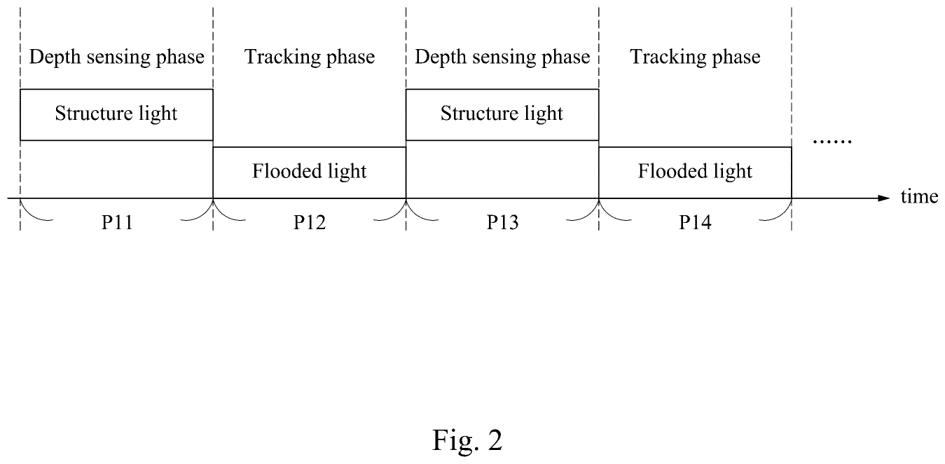

For example, if the ambient light is low, the tracking apparatus 1 controls the light emitting unit 16 in a time-sharing mode 1 illustrated in FIG. 2. As shown in FIG. 2, the tracking apparatus 1 performs object tracking and depth sensing alternatively in time. In depth sensing phases P11 and P13, the tracking apparatus 1 emits structured light for depth sensing. In contrast, in object tracking phases P12 and P14, the tracking apparatus 1 emits flood light for object tracking. Accordingly, through the time-sharing operation, the tracking apparatus 1 emits the corresponding light for object tracking and depth sensing and avoids light interference from structured light or flood light.

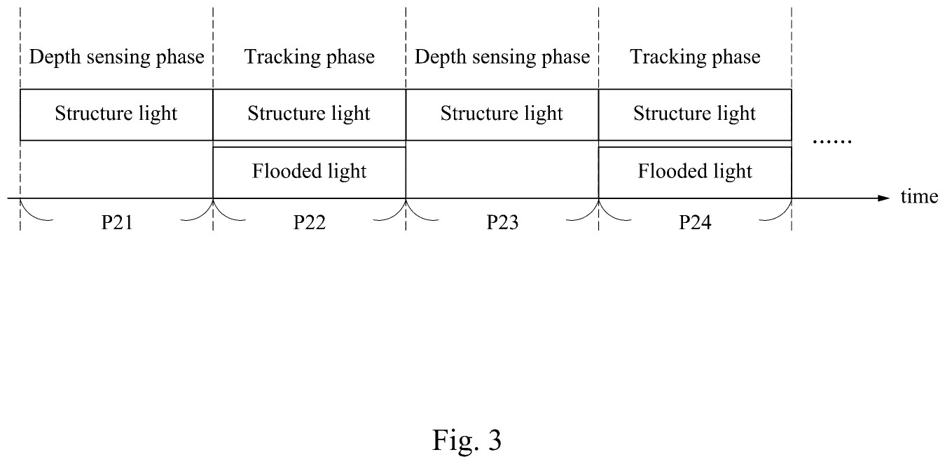

In another example, when the ambient light is too low for object tracking and the flood light is not enough to fill in the light, the tracking apparatus 1 controls the light emitting unit 16 in a time-sharing mode 2 illustrated in FIG. 3. As shown in FIG. 3, same as the time-sharing mode 1, the tracking apparatus 1 performs object tracking and depth sensing alternatively in time and only emits structured light in depth sensing phases P21 and P23. Differently, due to lack of the ambient light, the tracking apparatus 1 emits both structured light and flood light in object tracking phases P22 and P24 to provide enough light intensity for object tracking. However, while structured light and flood light are emitted simultaneously, the pattern or color arrangement of structured light may affect the appearance of objects in the image, resulting in reduced object tracking accuracy. Therefore, the tracking apparatus 1 needs to determine the structured light intensity to minimize interference and provide enough light in the meantime.

In order to determine the structured light intensity, the tracking apparatus 1 simulates the future tracking effects corresponding to different structured light intensities to further determine an optimum structured light intensity, and the details thereof will be illustrated in the following paragraphs.

First, the tracking apparatus 1 calculates multiple losses corresponding to different structured light intensities based on the previous images and the previous structured light intensities to estimate tracking effects under the structured light intensities at the subsequent time point.

Specifically, the processor 12 calculates a plurality of tracking errors under a plurality of hypothetical structured light intensities at a tracking time point based on the first continuous images and a plurality of past structured light intensities corresponding to the time interval, wherein the tracking time point is later than the time interval.

In some embodiments, the tracking errors are defined as the difference between a tracking result (i.e., a pose of an object) under a certain structured light intensity and the actual pose. Accordingly, the errors can be expressed by the

$$L = {e}_{t + 1} = ‖ Track ( {I}_{t + 1} ( {s}_{t + 1} ) ) - {p}_{t + 1} ‖ , \qquad ( formula 1 )$$

sₜ₊₁ represents the structured light intensity at a time point t+1, lₜ₊₁ represents an object image at the time point t+1, Track(lₜ₊₁(sₜ₊₁)) represents the tracking result (i.e., a pose of an object) based on the object image at the time point t+1 under the corresponding structured light intensity, pₜ₊₁ represents an actual pose of the object at the time point t+1. Accordingly, the tracking error L is defined as the difference (i.e., eₜ₊₁) between the tracking result at the time point t+1 and the actual pose, wherein the tracking error L corresponds to a certain structured light intensity sₜ₊₁.

In practical, due to the lack of the actual pose and the object image in the future, the tracking apparatus 1 calculates the tracking errors by using a loss model. The loss model is configured to calculate the tracking error based on multiple previous continuous images and the intensities of the structured light emitted when the previous continuous images are captured. Accordingly, to train the loss model, multiple sets of continuous images and the actual object pose in the last frame of each of the sets of continuous images are needed for training data. Furthermore, the tracking error corresponding to each set of the continuous images is able to be calculated through tracking the object pose in the last image among the continuous images and calculating the difference (i.e., the tracking error) between the object pose tracked and the actual pose. After obtaining the tracking errors, the sets of continuous images without the last frame and the structured light intensities corresponding to the sets of continuous images are taken as training data, and the training data is labeled by the tracking errors correspondingly.

Specifically, the operation of calculating the tracking errors further comprises inputting the first continuous images and the past structured light intensities into a loss model to calculate the tracking errors, and the loss model is trained through the following operations. For each of a plurality of sets of second continuous images, executing the following operations, wherein each of the sets of second continuous images comprises a plurality of continuous images and a reference image captured after the continuous images: generating an estimated pose by using a tracking model based on the reference image; calculating an estimated loss corresponding to the reference image based on the estimated pose and a first actual pose corresponding to the reference image; and training the loss model based on a first training data and a first label corresponding to the first training data, wherein the first training data comprises a structured light intensity corresponding to the reference image and a known factor corresponding to the continuous images, and the first label comprises the estimated loss corresponding to reference image. Accordingly, the trained loss model is able to predict the tracking error at the subsequent time point based on the previous images, the structured light intensities corresponding to the previous images, and the expected structured light intensity to be emitted at the subsequent time point.

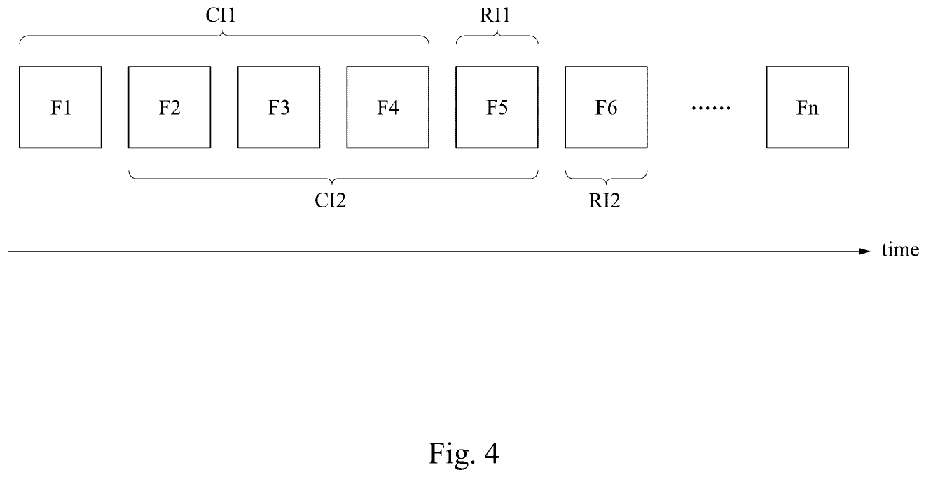

In some embodiments, a series of continuous images (e.g., a video) is segmented into multiple sets of continuous images for loss model training. For clarity, please refer to FIG. 4, which is a schematic diagram illustrating continuous images and a reference image for training the loss model according to some embodiments of the present disclosure.

As shown in FIG. 4, frames F1-Fn are continuous images of a video and are able to be segmented into multiple sets of continuous images as the training data. For example, the frames F1-F4 are segmented into a set of continuous images C11, and the frame F5 is taken as the corresponding reference image. Accordingly, an estimated pose is tracked based on the frame F5, and an estimated loss is calculated based on the estimated pose to label the set of continuous images C11. In addition, the intensities of structured light emitted while the frames F1-F4 and F5 are captured are also used for the training data. Similarly, the frames F2-F5 may be segmented into another set of continuous images, and the frame F6 is taken as the corresponding reference image, and so forth.

It is noted that, the embodiment shown in FIG. 4 is one of the implementation, and the present disclosure is not limited thereto. In other embodiments, the loss model may also be trained by multiple sets of continuous images not related to each other.

Moreover, in some embodiments, the training data of the loss model may also comprise factors related to the continuous images and the output of object tracking. For example, the factors comprise average light intensity in the whole continuous images, average light intensity on the object, the object pose, the distance between the object and the camera, the confidence of the object tracking result, and/or other related information. Accordingly, the loss model is able to further determine the tracking errors based on the factors. For example, the further the distance between the object and the camera, the higher the tracking error due to the lower resolution of the object image.

It is noted that, the tracking errors are used for determine the structured light intensity, thus, if the tracking apparatus 1 is not going to emit structured light, the tracking apparatus 1 does not need to calculate the tracking errors for the following operations. Specifically, in response to the light emitting unit not emitting the structured light, the processor 12 does not calculate the tracking errors.

After the tracking errors are calculated, the tracking apparatus 1 determines an optimum structured light intensity based on a minimum error among the tracking errors.

In some embodiments, in order to determine the optimum structured light intensity with a minimum loss between the tracking result and the actual pose, the processor 12 selects a minimum loss from the tracking errors as the minimum error; and the processor 12 selects one of the hypothetical structured light intensities corresponding to the minimum error as the optimum structured light intensity.

After the optimum structured light intensity is determined, the tracking apparatus 1 then emits the structured light under the optimum structured light intensity at the time point corresponding to the optimum structured light intensity. In the meantime, the tracking apparatus 1 may track the object in the environment under the optimum structured light intensity.

Specifically, the processor 12 generates a first control signal to control the light emitting unit 16 to emit the structured light with the optimum structured light intensity at the tracking time point; the processor 12 obtains a tracking image captured at the tracking time point from the first camera; and the processor 12 tracks a pose of a first object based on the tracking image.

In some embodiments, the tracking apparatus 1 tracks the object by using a tracking model. In order to improve the tracking accuracy for the image with structured light, the tracking model may be trained by using images with structured light.

Specifically, the operation of tracking the pose of the first object further comprises inputting the tracking image into a tracking model to track the pose, and the tracking model is trained through the following operation: training the tracking model based on a plurality of second training data and a plurality of second labels corresponding to the second training data, wherein the second training data comprises a plurality of training images, the training images comprise a plurality of images of a plurality of third objects irradiated by the structured light, and the second labels comprise a plurality of second actual poses corresponding to the third objects in the images.

In some embodiments, after each of the object tracking operations, the tracking apparatus 1 stores the latest image captured for the next object tracking operation. Specifically, the tracking apparatus 1 further comprises a storage (not shown in the figures) coupled to the processor 12, and the storage is configured to store the first continuous images. Correspondingly, the processor 12 stores the tracking image into the storage as one of the first continuous images.

In some embodiments, there may be multiple objects present in the environment. Accordingly, the tracking apparatus 1 calculates losses corresponding to each of the objects respectively and calculates the tracking errors based on the losses. Specifically, the processor 12 calculates an object loss of each of a plurality of second objects in the environment based on the first continuous images and the past structured light intensities corresponding to the time interval; and the processor 12 calculates the tracking errors based on the object loss of each of the second objects.

For example, for each of the objects, the tracking apparatus 1 calculates a loss through the aforementioned operation, and then takes the average of the losses as the tracking error. In another example, each of the objects corresponding to a weight. After calculating the losses corresponding to the objects, the tracking apparatus 1 calculates the tracking errors by using the weights to adjust the degree of involvement of each object.

In some embodiments, the tracking apparatus 1 comprises multiple cameras configured to capture images in different angles. Similarly, the tracking apparatus 1 calculates losses corresponding to each of the images captured by the cameras at the same time respectively and calculates the tracking errors based on the losses. Specifically, the tracking apparatus 1 further comprises a second camera coupled to the processor and configured to capture a plurality of third continuous images in the environment over the time interval. The operation of calculating the tracking errors further comprises: the processor 12 calculates a plurality of first sight losses under the hypothetical structured light intensities at the tracking time point based on the first continuous images and the past structured light intensities; the processor 12 calculates a plurality of second sight losses under the hypothetical structured light intensities at the tracking time point based on the third continuous images and the past structured light intensities; and the processor 12 calculates the tracking errors based on the first sight losses and the second sight losses.

Similar to the embodiment of multiple objects above, the tracking apparatus 1 may also obtain the tracking errors by calculating the average of the losses corresponding to each camera or further using weights corresponding to the cameras.

In another example, when there are multiple objects, and the tracking apparatus 1 comprises multiple cameras, the tracking apparatus 1 calculates the losses of each object captured by each camera respectively. Accordingly, the tracking apparatus 1 averages the losses as the tracking errors or calculates the tracking errors based on the weights corresponding to the objects and the weights corresponding to the cameras.

In summary, when there is not enough ambient light, the tracking apparatus 1 will emit flood light and/or structured light for object tracking and/or depth sensing. Since structured light may interfere with the object tracking accuracy, the tracking apparatus 1 determines the optimum structured light intensity to balance the accuracy and interference. Additionally, when emitting structured light, the tracking apparatus 1 performs object tracking by using a tracking model trained by images with structured light to reduce the accuracy interference. Also, when the tracking apparatus 1 comprises multiple cameras for object tracking, or there are multiple objects to be tracked, the tracking apparatus 1 is also able to determine the optimum structured light intensity.

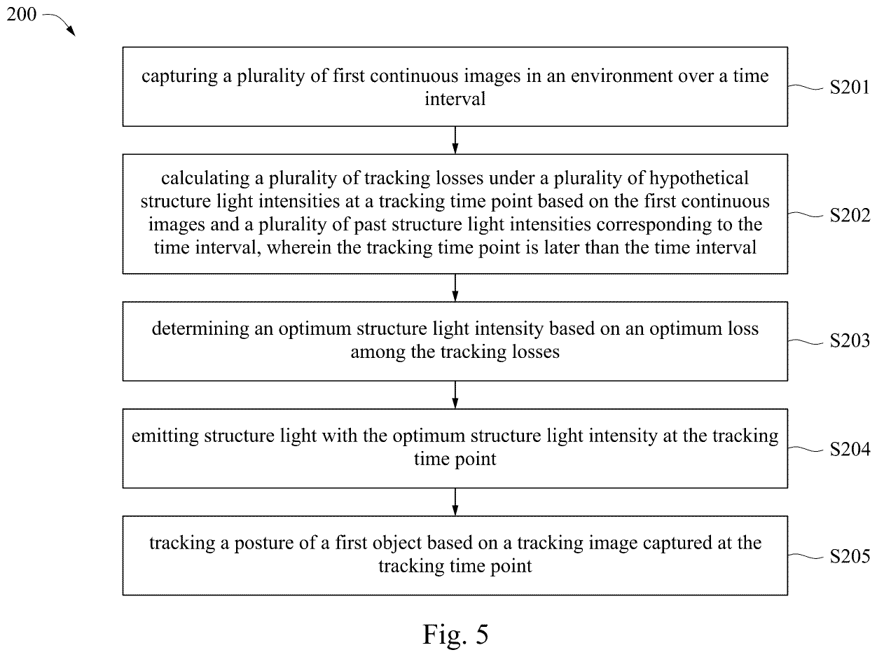

Please refer to FIG. 5, which is a flow diagram illustrating a tracking method 200 according to a second embodiment of the present disclosure, wherein the tracking method 200 comprises steps S201-S205. The tracking method 200 is adapted for use in an electronic apparatus (e.g., the tracking apparatus 1).

First, in the step S201, the electronic apparatus captures a plurality of first continuous images in an environment over a time interval.

Next, in the step S202, the electronic apparatus calculates a plurality of tracking errors under a plurality of hypothetical structured light intensities at a tracking time point based on the first continuous images and a plurality of past structured light intensities corresponding to the time interval, wherein the tracking time point is later than the time interval.

Next, in the step S203, the electronic apparatus determines an optimum structured light intensity based on a minimum error among the tracking errors.

Next, in the step S204, the electronic apparatus emits structured light with the optimum structured light intensity at the tracking time point.

Finally, in the step S205, the electronic apparatus tracks a pose of a first object based on a tracking image captured at the tracking time point.

In some embodiments, the step S202 further comprises the electronic apparatus inputting the first continuous images and the past structured light intensities into a loss model to calculate the tracking errors, and the loss model is trained through the following steps. For each of a plurality of sets of second continuous images, executing the following steps, wherein each of the sets of second continuous images comprises a plurality of continuous images and a reference image captured after the continuous images: generating an estimated pose by using a tracking model based on the reference image; calculating an estimated loss corresponding to the reference image based on the estimated pose and a first actual pose corresponding to the reference image; and training the loss model based on a first training data and a first label corresponding to the first training data, wherein the first training data comprises a plurality of structured light intensities corresponding to the continuous images and the reference image and the continuous images, and the first label comprises the estimated loss corresponding to reference image.

In some embodiments, the step S202 further comprises the electronic apparatus calculating an object loss of each of a plurality of second objects in the environment based on the first continuous images and the past structured light intensities corresponding to the time interval; and the electronic apparatus calculating the tracking errors based on the object loss of each of the second objects.

In some embodiments, the step S202 further comprises the electronic apparatus capturing a plurality of third continuous images in the environment over the time interval; the electronic apparatus calculating a plurality of first sight losses under the hypothetical structured light intensities at the tracking time point based on the first continuous images and the past structured light intensities; the electronic apparatus calculating a plurality of second sight losses under the hypothetical structured light intensities at the tracking time point based on the third continuous images and the past structured light intensities; and the electronic apparatus calculating the tracking errors based on the first sight losses and the second sight losses.

In some embodiments, the step S203 further comprises the electronic apparatus selecting a minimum loss from the tracking errors as the minimum error; and the electronic apparatus selecting one of the hypothetical structured light intensities corresponding to the minimum error as the optimum structured light intensity.

In some embodiments, the step S205 further comprises the electronic apparatus inputting the tracking image into a tracking model to track the pose, and the tracking model is trained through the following step: training the tracking model based on a plurality of second training data and a plurality of second labels corresponding to the second training data, wherein the second training data comprises a plurality of training images, the training images comprise a plurality of images of a plurality of third objects irradiated by the structured light, and the second labels comprise a plurality of second actual poses corresponding to the third objects in the images.

In some embodiments, the tracking method 200 further comprises in response to an ambient brightness in the environment lower than a first threshold, the electronic apparatus emitting flood light and stop emitting the structured light to capture the first continuous images.

In some embodiments, the tracking method 200 further comprises in response to an ambient brightness in response to the ambient brightness in the environment lower than a second threshold, the electronic apparatus emitting the flood light and the structured light to capture the first continuous images, wherein the second threshold is lower than the first threshold.

In some embodiments, the tracking method 200 further comprises in response to a tracking function and a depth sensing function being activated at the same time, after tracking the pose of the first object, the electronic apparatus emitting the structured light and stop emitting the flood light; and after emitting the structured light and stop emitting the flood light, the electronic apparatus executing the depth sensing function.

In some embodiments, the tracking method 200 further comprises after completing the depth sensing function, the electronic apparatus controlling a flood light intensity of the flood light and a structured light intensity of the structured light; and after controlling the flood light intensity and the structured light intensity, the electronic apparatus tracking the pose of the first object.

In some embodiments, the tracking method 200 further comprises in response to not emitting the structured light, the electronic apparatus not calculating the tracking errors.

In some embodiments, the tracking method 200 further comprises the electronic apparatus storing the tracking image as one of the first continuous images.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A tracking apparatus, comprising:
a first camera, configured to capture a plurality of first continuous images in an environment over a time interval;
a light emitting unit, configured to emit structured light to the environment; and
a processor, coupled to the first camera and the light emitting unit, and configured to execute the following operations:
calculating a plurality of tracking errors under a plurality of hypothetical structured light intensities at a tracking time point based on the first continuous images and a plurality of past structured light intensities corresponding to the time interval, wherein the tracking time point is later than the time interval;
determining an optimum structured light intensity based on a minimum error among the tracking errors;
generating a first control signal to control the light emitting unit to emit the structured light with the optimum structured light intensity at the tracking time point;
obtaining a tracking image captured at the tracking time point from the first camera; and
tracking a pose of a first object based on the tracking image.

2. The tracking apparatus of claim 1, wherein the operation of calculating the tracking errors further comprises inputting the first continuous images and the past structured light intensities into a loss model to calculate the tracking errors, and the loss model is trained through the following operations:
for each of a plurality of sets of second continuous images, executing the following operations, wherein each of the sets of second continuous images comprises a plurality of continuous images and a reference image captured after the continuous images:
generating an estimated pose by using a tracking model based on the reference image;
calculating an estimated loss corresponding to the reference image based on the estimated pose and a first actual pose corresponding to the reference image; and
training the loss model based on a first training data and a first label corresponding to the first training data, wherein the first training data comprises a plurality of structured light intensities corresponding to the continuous images and the reference image and the continuous images, and the first label comprises the estimated loss corresponding to reference image.

3. The tracking apparatus of claim 1, wherein the operation of calculating the tracking errors further comprises:
calculating an object loss of each of a plurality of second objects in the environment based on the first continuous images and the past structured light intensities corresponding to the time interval; and
calculating the tracking errors based on the object loss of each of the second objects.

4. The tracking apparatus of claim 1, further comprising:
a second camera, coupled to the processor, and configured to capture a plurality of third continuous images in the environment over the time interval;
wherein the operation of calculating the tracking errors further comprises:
calculating a plurality of first sight losses under the hypothetical structured light intensities at the tracking time point based on the first continuous images and the past structured light intensities;
calculating a plurality of second sight losses under the hypothetical structured light intensities at the tracking time point based on the third continuous images and the past structured light intensities; and
calculating the tracking errors based on the first sight losses and the second sight losses.

5. The tracking apparatus of claim 1, wherein the operation of determining the optimum structured light intensity further comprises:
selecting a minimum loss from the tracking errors as the minimum error; and
selecting one of the hypothetical structured light intensities corresponding to the minimum error as the optimum structured light intensity.

6. The tracking apparatus of claim 1, wherein the operation of tracking the pose of the first object further comprises inputting the tracking image into a tracking model to track the pose, and the tracking model is trained through the following operation:
training the tracking model based on a plurality of second training data and a plurality of second labels corresponding to the second training data, wherein the second training data comprises a plurality of training images, the training images comprise a plurality of images of a plurality of third objects irradiated by the structured light, and the second labels comprise a plurality of second actual poses corresponding to the third objects in the images.

7. The tracking apparatus of claim 1, wherein the light emitting unit is further configured to emit flood light to the environment, and the processor is further configured to execute the following operation:
in response to an ambient brightness in the environment lower than a first threshold, generating a second control signal to control the light emitting unit to emit the flood light and stop emitting the structured light to let the camera to capture the first continuous images.

8. The tracking apparatus of claim 7, wherein the processor is further configured to execute the following operation:
in response to the ambient brightness in the environment lower than a second threshold, generating a third control signal to control the light emitting unit to emit the flood light and the structured light to let the camera to capture the first continuous images, wherein the second threshold is lower than the first threshold.

9. The tracking apparatus of claim 1, wherein the light emitting unit is further configured to emit flood light to the environment, and the processor is further configured to execute the following operations:
in response to a tracking function and a depth sensing function being activated at the same time, after tracking the pose of the first object, generating a fourth control signal to control the light emitting unit to emit the structured light and stop emitting the flood light; and
after generating the fourth control signal, executing the depth sensing function.

10. The tracking apparatus of claim 9, wherein the processor is further configured to execute the following operations:
after completing the depth sensing function, generating a fifth control signal to control a flood light intensity of the flood light and a structured light intensity of the structured light emitted by the light emitting unit; and
after generating the fifth control signal, tracking the pose of the first object.

11. The tracking apparatus of claim 1, wherein the processor is further configured to execute the following operation:
in response to the light emitting unit not emitting the structured light, not calculating the tracking errors.

12. The tracking apparatus of claim 1, further comprising:
a storage, coupled to the processor, and configured to store the first continuous images;
wherein the processor is further configured to execute the following operation:
storing the tracking image into the storage as one of the first continuous images.

13. A tracking method, being adapted for use in an electronic apparatus, wherein the tracking method comprises the following steps:
capturing a plurality of first continuous images in an environment over a time interval;
calculating a plurality of tracking errors under a plurality of hypothetical structured light intensities at a tracking time point based on the first continuous images and a plurality of past structured light intensities corresponding to the time interval, wherein the tracking time point is later than the time interval;
determining an optimum structured light intensity based on a minimum error among the tracking errors;
emitting structured light with the optimum structured light intensity at the tracking time point; and
tracking a pose of a first object based on a tracking image captured at the tracking time point.

14. The tracking method of claim 13, wherein the step of calculating the tracking errors further comprises inputting the first continuous images and the past structured light intensities into a loss model to calculate the tracking errors, and the loss model is trained through the following steps:
for each of a plurality of sets of second continuous images, executing the following steps, wherein each of the sets of second continuous images comprises a plurality of continuous images and a reference image captured after the continuous images:
generating an estimated pose by using a tracking model based on the reference image;
calculating an estimated loss corresponding to the reference image based on the estimated pose and a first actual pose corresponding to the reference image; and
training the loss model based on a first training data and a first label corresponding to the first training data, wherein the first training data comprises a plurality of structured light intensities corresponding to the continuous images and the reference image and the continuous images, and the first label comprises the estimated loss corresponding to reference image.

15. The tracking method of claim 13, wherein the step of calculating the tracking errors further comprises:
calculating an object loss of each of a plurality of second objects in the environment based on the first continuous images and the past structured light intensities corresponding to the time interval; and
calculating the tracking errors based on the object loss of each of the second objects.

16. The tracking method of claim 13, wherein the step of calculating the tracking errors further comprises:
capturing a plurality of third continuous images in the environment over the time interval;
calculating a plurality of first sight losses under the hypothetical structured light intensities at the tracking time point based on the first continuous images and the past structured light intensities;
calculating a plurality of second sight losses under the hypothetical structured light intensities at the tracking time point based on the third continuous images and the past structured light intensities; and
calculating the tracking errors based on the first sight losses and the second sight losses.

17. The tracking method of claim 13, wherein the step of determining the optimum structured light intensity further comprises:
selecting a minimum loss from the tracking errors as the minimum error; and
selecting one of the hypothetical structured light intensities corresponding to the minimum error as the optimum structured light intensity.

18. The tracking method of claim 13, wherein the step of tracking the pose of the first object further comprises inputting the tracking image into a tracking model to track the pose, and the tracking model is trained through the following step:
training the tracking model based on a plurality of second training data and a plurality of second labels corresponding to the second training data, wherein the second training data comprises a plurality of training images, the training images comprise a plurality of images of a plurality of third objects irradiated by the structured light, and the second labels comprise a plurality of second actual poses corresponding to the third objects in the images.

19. The tracking method of claim 13, further comprising:
in response to an ambient brightness in the environment lower than a first threshold, emitting flood light and stop emitting the structured light to capture the first continuous images; and
in response to the ambient brightness in the environment lower than a second threshold, emitting the flood light and the structured light to capture the first continuous images, wherein the second threshold is lower than the first threshold.

20. The tracking method of claim 13, further comprising:
in response to a tracking function and a depth sensing function being activated at the same time, after tracking the pose of the first object, emitting the structured light and stop emitting flood light;
after emitting the structured light and stop emitting the flood light, executing the depth sensing function;
after completing the depth sensing function, controlling a flood light intensity of the flood light and a structured light intensity of the structured light; and
after controlling the flood light intensity and the structured light intensity, tracking the pose of the first object.
